(19) United States
(12) Patent Application Publication
(10) Pub. No.: US 2013/0079130 A1
(43) Pub. Date: Mar. 28, 2013

(54) FANTASY SPORTS GAME

(71) Applicant: John Takacs, Buffalo, NY (US)

(72) Inventor: John Takacs, Buffalo, NY (US)

(21) Appl. No.: 13/244,603

(22) Filed: Sep. 25, 2011

(51) Int. Cl. A63F 13/00

(52) U.S. Cl. 463/31

(57) ABSTRACT

A fantasy sports game allows a user to obtain a roster corresponding to a real-life sports team's roster and adjust the roster via transactions based on real-life transactions. The participant's roster is scored against the real-life sports team's roster.

### BACKGROUND OF THE INVENTION

This invention relates to fantasy sports. More specifically, the invention relates to an immersive fantasy sports game in which a participant can pit his skills against that of a GM managing a corresponding real-life sports team.

### SUMMARY OF THE INVENTION

Beat the GM (BTGM) is a game/application that utilizes sports news and data to enable users to take control of and manage their favorite professional sports franchise. BTGM is structured in such a way that users are able to compare their results to/compete against other users as well as the real life general manager of the professional franchise.

The four characteristics unique to BTGM are: (1) BTGM uses real life transactions (e.g.—signings, trades, etc) to catalyze and set parameters for options then made available to users. (2) Each transaction option is independently made available to every user, regardless of team affiliation. There is an infinite player pool. (3) A draft process that utilizes the results of real life selections to create an experience that provides users with accurate selection options for any given draft position. (4) The foundation of aforementioned unique characteristic 1 provides users with the ability to directly evaluate their choices and subsequent results as “general manager” with the actual general manager of the real life franchise.

BTGM can be used with any professional sport including but not limited to: football, baseball, basketball, hockey, soccer, rugby, lacrosse, and cricket.

The preferred execution of BTGM is via website application; however other mediums with which BTGM can be played include but are not limited to: video games, computer programs, board games, and hand managed leagues.

### BRIEF DESCRIPTION OF THE DRAWING FIGURES

FIGS. 1-12 are representative screen shots of a computer-based fantasy sports game according to aspects of the invention.

### DETAILED DESCRIPTION OF PREFERRED EMBODIMENTS

### Description of Beat the GM Primary Application

### Team Selection

In the primary application of BTGM, a user will begin by selecting their favorite sports team. Upon selection, the user assumes control (becomes the general manager) of the team's real life roster as constructed at the time of selection including any practice squad, minor league, developmental team, or any other associated affiliates on whom there is a player for which the parent club has professional rights.

### Transactions

In order to change the composition of their team, users will be given transaction opportunities. These transaction opportunities (signings, trades, etc.) will only be available after they have occurred in real life. The opportunity will be presented to the user with the same parameters as agreed to or reported in real life. The user may then choose to accept a transaction based on those terms or refuse the transaction entirely. The principle at play is that the real life transaction occurred under the most favorable terms possible for the other party and by agreeing to those terms, the user then becomes the team with the highest bid for a player's services.

Each user will be presented with the same opportunity providing they meet certain parameters of the real life transaction, including any salary cap or budgetary restrictions. Thus, the game may include roster restrictions with which the participant will have to comply. For example, they may be limited by a salary cap and/or a roster size, which restrictions may correspond to restrictions applicable to a real-life sports team. In one embodiment, there is no competition for resources. Multiple users/managers in the game are able to independently decide on and acquire an available player.

For example, if a player signs a contract with any team in the real life league, the user may add that player to their roster as long as they agree to the general terms of the new real life contract. A second example, if two real life teams initiate a trade of either or a combination of players, draft picks or money, the user may also obtain the benefits of that trade if they have the same assets to trade away—either the player that has been traded, draft picks, or available money—and agree to the general terms of the real life trade.

In one embodiment, the user will not be able to engage in any unilateral roster decisions as they pertain to transactions except for releasing a player. The principle at play is that any decision that requires a second party to agree to terms—another team, player, agent, etc.—will not be met with favorably and therefore not allowed. In the example of releasing a player, a general manager can make that decision without the concurrence of the released party.

### Draft

Similar to the real life sport, a draft process will be implemented when/if called for. Just as a user inherits and manages players, the user will inherit and manage a team's draft picks. In a preferred embodiment used in this game, for the draft process a master draft list will be compiled from results of the real life draft. Users will then be able to make their selections at each of their assigned draft positions from only the players remaining on the master list when that position selected from real life. For example, if the user picks third overall, they can pick any player except for the two that were selected first and second overall in the real life draft.

### Roster Management

In addition to transactions, a user can adjust various aspects of his squad including but not limited to the team's depth chart. This ordering can be done several ways including by player and/or by position to determine who on the user's roster is assigned as the starter, substitute, inactive, minor leaguer, or any other designation as consistent with the practices of the respective professional sport.

To assist in all of the user's decisions, various data and statistics are made available. This information is drawn from a variety of sources either internally generated, found in the public domain, or accessed by permission. Information can be categorized and organized into easily understood formats such as a statistical chart similar to the ones found in the sports section of a newspaper.

### Scoring

The goal of the user is to assemble a better roster than his or her friends and/or the team's real life general manager. In order to accomplish this comparison, one or more performance based scoring systems are utilized. These are systems based on actual happenings on the field, not simulations. They include, but are not limited to: A fantasy sports based scoring system—assigns a numeric point value for a specific statistic and then tabulates a final total. An observation based scoring system—assigns a score (e.g., a numeric score) based on an evaluator's analysis of a particular player's performance, which is then tabulated for a final score. A dynamic scoring formula creates a “win,” “loss” or “tie” result based on a process that generates a unique mathematical formula for each real life game.

More specifically, the Dynamic Scoring Formula creates a unique algebraic formula for each real life match-up factoring in the final score and statistics of each real life game and roster. The real life statistics can then be substituted with each user's respective roster's statistics to determine how the user's team would have fared in that specific match-up, resulting in a “win,” “loss” or “tie” score.

An illustrative example of the BTGM Dynamic Scoring Formula follows. Of course, this example is simplified for purposes of illustration. The actual formula may take into account points, rushing yards and passing yards but may also include one or more performance criteria including but not limited to, receiving yards, third-down conversion efficiency, tackles, sacks and penalties:
1. Final score is: Buffalo 14, Cleveland 3.
2. Statistics: Buffalo—Rush Yards 212, Pass Yards 311. Cleveland—Rush Yards 91, Pass Yards 118. (Formula can incorporate a vast number of categories. Simplified for purposes of this example).
3. Looking at the final score, Buffalo's score of 14 is 4.66 times greater than Cleveland's score of 3.
4. Formula for the statistics becomes: 212a+311b>91a+118b.
5. Therefore, the formula combining the final score and statistics becomes 212a+311b=4.66(91a+118b).
6. Values for “a” and “b” are then determined.
7. A user managing the “Cleveland” team then substitutes in their players total statistics, for example Rush Yards 222, Pass Yards 342.
8. The formula then becomes 212a+311b?222a+342b while also plugging in the values determined for “a” and “b” in step 6.
9. If the value on the right side of the “?” is greater than the value on the left, then the result is a “Win” for the user. If it is less, then it is a “Loss.”

Other comparisons may also be used. For example, in other embodiments, the comparison may be done on a per-player basis. Here, each player could be graded based on performance in the given match, with a cumulative grade being given to the entire roster. It is then possible to compare this cumulative grade to a grade taken for a real-life team or to determine results against that team. Moreover, the value for the participant's team could be compared to a score of an opposing participant.

Modifications to the idea are also contemplated. Such modifications include:
BTGM will be available for a variety of sports.
Users may obtain roster as is on selection date or as it was structured on previous dates.
Transaction opportunities made available to users can happen in real time or be posted on a subsequent date.
Transaction parameters may be estimates based on reports and adjusted later when further details emerge. This revision may then be re-presented to the user. Examples of such a re-presentation include but are not limited to: reposting the transaction opportunity anew or allowing the user to void the earlier transaction without penalty.
Transaction parameters may be adjusted from real life by the application's administrator or moderator.
The game may also allow for negotiation of transactions parameters based on various factors including but not limited to player value, draft pick value, or monetary value charts.
Trading or moving a draft pick may be revalued to a higher package by the administrator.
The game also may create competition for resources. This would result in a finite pool of players and limited availability of transaction opportunities. Most likely occurring in user leagues, transaction opportunities would then be the result of some sort of user competition including but not limited to bidding. In this instance, no two users could own the same player.
Unilateral decisions may extend beyond releasing a player.

### Layout/Technical Description of Beat the GM

The following description of Beat The GM presents the idea in its preferred method of a web-based application.

Upon sign up and selection of a team, the user will be directed to a HOME PAGE, which is one of several key headings including: HOME, TEAM, MATCH-UP, DATA, COMMUNITY, and FAQ.

### Home Page

The Home Page serves as the personal site summary for the user. There may be several sections, each with brief, linkable summaries to dedicated pages. An important one of these is Transactions That and others include:
My BTGM—Messages or tips from moderators or administrators to the users. These will typically include ways to use the site more effectively or notices of changes, improvements, or deadlines. (See page 13)
Transactions—This is where all transaction opportunities are listed. In one embodiment this may include four subpages: Pending, History, Search, Scoop. (See page 14)
   1. Pending—All transactions available for user to select, including but not limited to: sign, trade, and release. Users are given two options: a “yes” or appropriate execute option and a “no” or appropriate deny option. All transactions posted reflect a real life transaction with real life parameters. Data displayed includes but is not limited to: date posted, type of transaction, player position, player name, original date of transaction, previous team, new team, terms (salary, years, bonus, guarantees, etc), source for info, player statistics, and other links. Transactions are only available to the user for a specific window of time.
   2. History—Lists transactions made by the user over some relevant time period. This time period may be as long as from acquisition of the team.
   3. Search—Offers the ability for a user to enter a player's name and search to determine their present or past transaction status.
   4. Scoop—Enables the user to send the administrator a message based on new information that specifically addresses transactions not yet appearing on the site. There are few if any up-to-date publications that catalog all transactions and these terms. Accordingly, BTGM allows a user to request that a transaction be included by an administrator of the game. The administrator is then tasked with determining the particulars of the transaction to report same to the users or to confirm the parameters presented by the reporting user.
Player News—News or info from around the league. This may be obtained through digital feeds such as RSS or direct entry by administrator. The info can be filtered by the user based on available options such as: display entire league, by team, by position, by user players only, etc.
Blogs—Articles obtained from outside sources, written internally, or written by users.
Trophies—This sections displays awards earned by the user.
Profile—Displays various personal information from vitals such as name and date of birth to more playful items such as favorite game ever attended. New questions may be introduced at any time. Answers can be private or viewed by other users, depending on an individual's chosen settings.
Settings—Lists all the website functions that are customizable for the user.

### Team

The Team pages serve as the primary area for player organization and options within the team. There are several sections, each offering different approaches to roster and draft organization.
Roster List—A list of all the players on the team with accompanying information. Info can be displayed in various denominations including but not limited to: career, season, or game. (See page 15)
   1. Player Stats—Lists statistics and relevant scores of players.
   2. Player Awards—Lists awards or acknowledgements earned by player. For example, most valuable player or player of the year.
   3. Salary—Lists each player's salary as broken down by year. When appropriate, the salary is broken down into key components such as: base pay, bonus money, and incentives. The total or components of this information may be used to determine that player's total salary as it pertains to any applicable salary cap. (See page 16) Thus, a total team salary can be readily calculated, i.e., for comparison against a salary cap.
Roster Layout—This is where a user can see how their line-up looks in a lineup/diagram form. (See page 17)
   1. Depth Chart—Allows user to rank players within the team and within positions.
   2. Compare—Allows users to see how their lineup looks as compared to other users or general managers.
Draft—Lists team's available draft picks and serves as the section where users will select players during the draft period.
   1. Picks—Lists past, current, and future selections or draft positions.
   2. Draft—During the draft period, user will be allowed to select from eligible players. A list resulting from the real life draft will serve as the guide for the draft format. Eligible player information includes but is not limited to: Real life draft position, on field position, name, and school. Users will be able to select any eligible player that was not selected in the real life draft prior to the user's selection position. This process continues until user has satisfied all selections and the draft is completed. (See page 18)

### Match-Up

The Match-Up section deals with the listing of and comparisons to the team's opponents. There are multiple sections, each varying in the type and format of information displayed. (See page 19)
Schedule—Lists a team's schedule for the season and any applicable results.
Match-Up—Selecting from any season in the schedule, the user can view various information including but not limited to statistics and scores of any real life or friend's team for any given game.

### Data

The Data pages display records of various types of information on players and users. The information can be organized in several ways including but not limited to: career, lifetime, season, week, game, person, team, and position. There are multiple sections, each varying in the type and format of information displayed. (See page 20)
Scores—Shows a record of the types of scores earned by teams and users as described in “Scoring” section of Description of Primary Application on Page 5.
Transactions—Provides a record of the decisions made by real life teams and/or users for any given transaction.
Stats—Displays any and all statistical data for any given player's on field performance. This information can be displayed as a straightforward list or in columns, thereby allowing users to create comparisons between players, teams, and/or users.

### Community

The Community section is where users are able to interact with one another. There are multiple sections, each focusing on a particular community dynamic. Within each section, there are various tools and functions that enable a user view the information of and communicate with fellow members.
Friends—This section allows users to correspond with and view the team information of fellow users with which they have established a relationship (aka—“Friend”). User correspondences can occur by several methods including but not limited to: messaging, message boards, comments, posts, and blogs. Users can also send invitations to individuals not already participating in BTGM. (See page 21)
Groups—This section provides the same functionality as the Friends section, but also allows users to organize in specifically themed groups. Users can create and manage the group's content as well as manage its' membership. These groups can be created by users or moderators/administrators and be public or private. (See page 22)

The accompanying figures illustrate an example layout for a user interface, such as a website, implementing a fantasy game according to the invention.

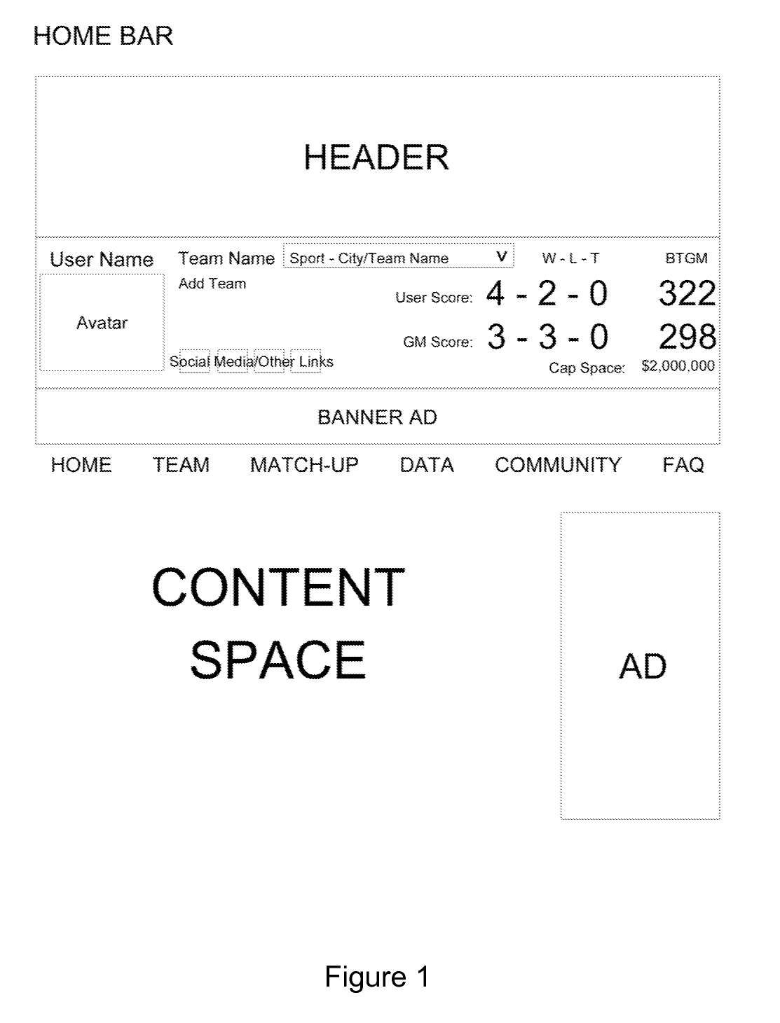

Specifically, FIG. 1 shows:

a page entitled USER HOME BAR including
User Name—Input by User upon Registration
Avatar/Pic—Uploaded by User in Profile
Team—Lists sport and city name
   Stores all user teams
   Drop down list
Add Team—Link to create/add team
User Score—Displays various user scores including:
   oBTGM score
   oWin/loss score
   Scoring difference between User and GM score
GM Score—Displays various GM scores
   Always same scoring type as displayed for User
Icons—In site or external links
   Social media links/apps
Cap Space—Displays remaining salary cap space for User's selected team

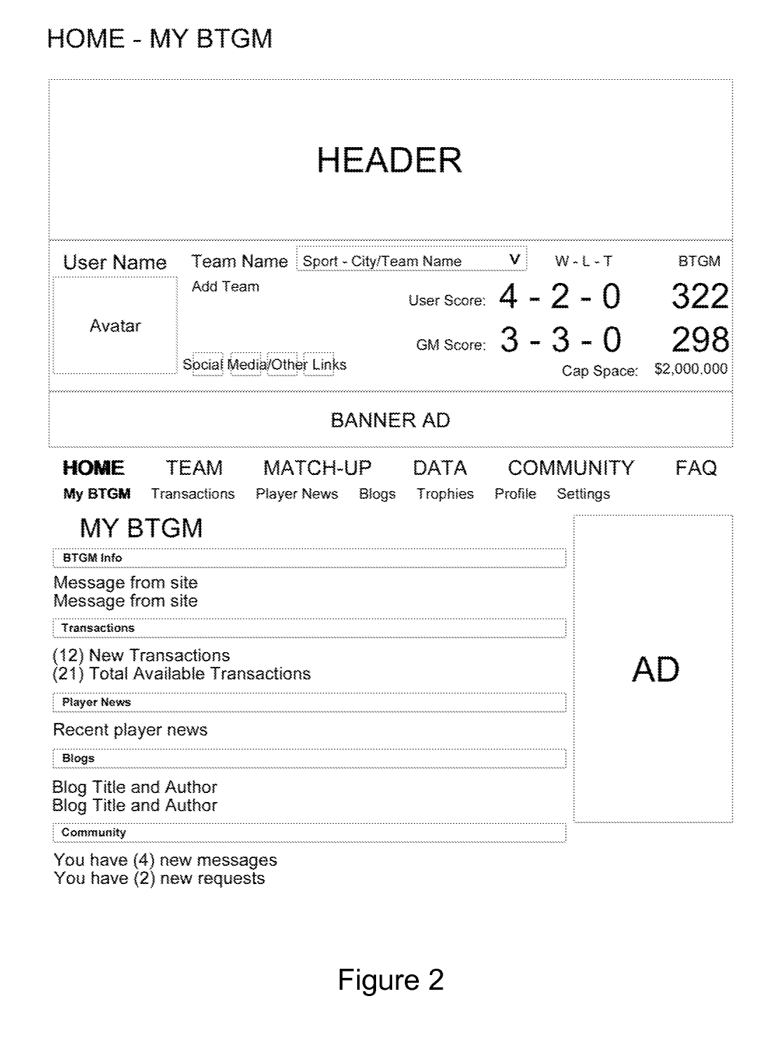

FIG. 2 shows a page entitled USER HOME—MY BTGM and includes:
Links to Pages: My BTGM, Transactions, Player News, Blogs, Trophies, Profile, Settings
Page Title—“My BTGM”
Section Heading—“BTGM Info”
   Displays messages, tips, or other info from Administrator/Site
Section Heading—“Transactions”
   Displays number of new transactions since last User visit
   Displays number of total available transactions
   Links to Transactions page
Section Heading—“Player News”
   Displays most recent player news for players on User's team
   Option to select from other filters including league or real team
   Data can be input by Administrator of via data feed
   Links to Player News page
Section Heading—“Blogs”
   Displays blog titles and authors
   Blogs can be created by Administrator, Users, or External Source
   Links to specific blog
Section Heading—“Community”
   Displays number of new messages
      Links to Messages
   Displays number of friend requests
      Links to Requests

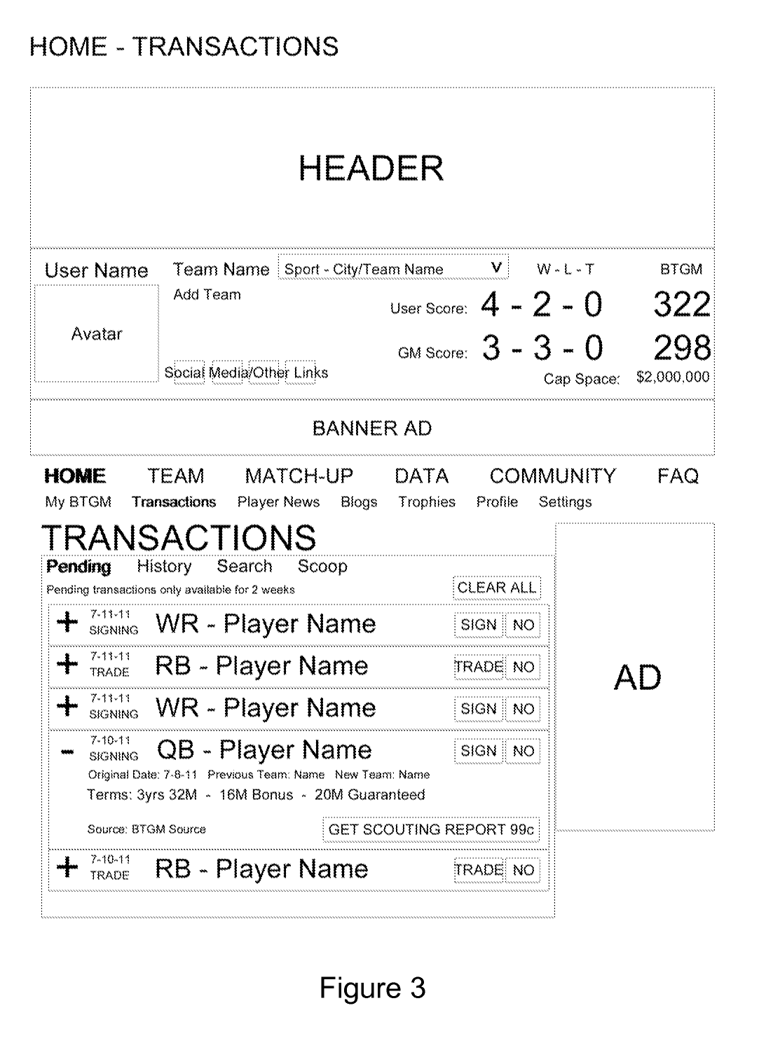

FIG. 3 illustrates a page entitled USER HOME—TRANSACTIONS and includes:
Page Title—“Transactions”
Links to Subpages: Pending, History, Search, Scoop
Text—“Pending transactions only available for 2 weeks”
Button “Clear All”—Clears all pending transactions
Posting of Transaction
   Includes: Date posted, type of transaction, position, and player name
   Multiple players may appear in trade
Button “Sign” or other execute options
   Includes: Sign, Trade, and Release
Button “No”
Expand (Plus) Icon
   Expands to reveal: Original date, previous team, new team, terms (overall salary, bonuses, guarantees, and incentives), and source.
Button “Get Scouting Report 99c”—Links to opportunity to order prepared player report

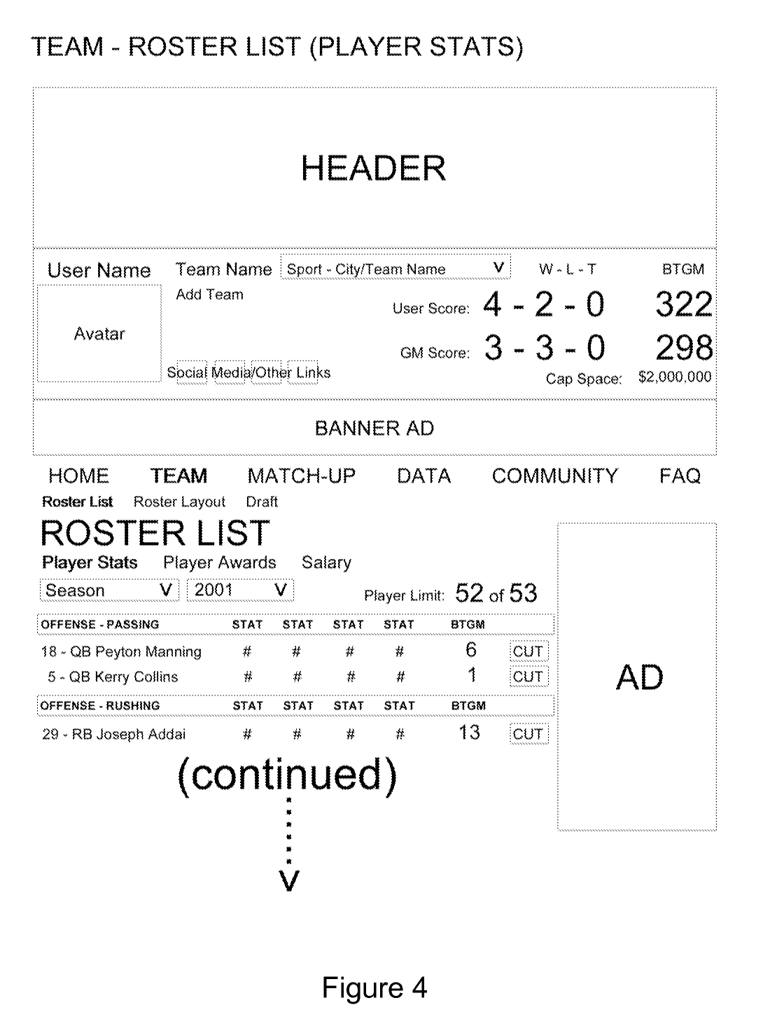

FIG. 4 illustrates a page entitled TEAM—ROSTER LIST (STATS) and includes:
Links to Pages: Roster List, Roster Layout, Draft
Page Title—“Roster List”
Links to Subpages: Player Stats, Player Awards, Salary
Range—Lists range of time
   Includes: Career, Season, and Week
   Drop Down list
Denominations of Range—Adjusts according to item selected in Range
   Career—NA, Season—Years, Weeks—1-16
   Drop Down list
Text—“Player limit”
Number of players on team
Number of players allowed on team
Category Bar—In this example “Offense—Passing” and “Offense—Rushing”
   Each bar will have differing titles
   Each bar will have stats relevant to the title
   Each bar will have a BTGM score for each player
Player Info: Number, Position, and Name
Actual stats for each player organized into appropriate column per heading in Category Bar
Identifier after player name if necessary—IR (Injured Reserve), PS (Practice Squad)
BTGM Score—Appears in BTGM column in Category Bar for each respective player
Button “Cut”—Releases player while incorporating all appropriate salary penalties

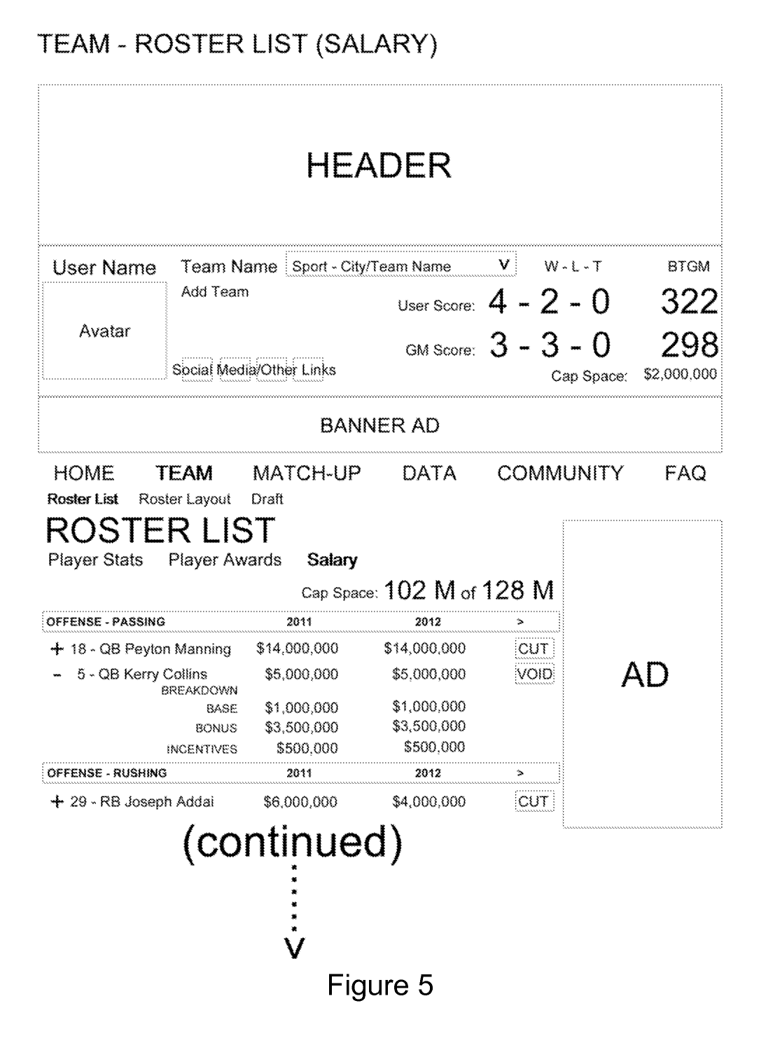

FIG. 5 illustrates a page entitled TEAM—ROSTER LIST (SALARY) and includes:
Similar to Team—Roster List (Salary)
No Range or Denomination
Text—“Salary Cap”
Total salary of players on team
Total salary allowed of players on team
Category Bar similar except relevant stats replaced by years
Salary of each player appears in the appropriate column according to year
Button “Void”—Release of player with no penalty to User
Expand (Plus) Icon
   Expands to reveal: Breakdown of Player Salary, Base, Signing Bonus, and Incentives

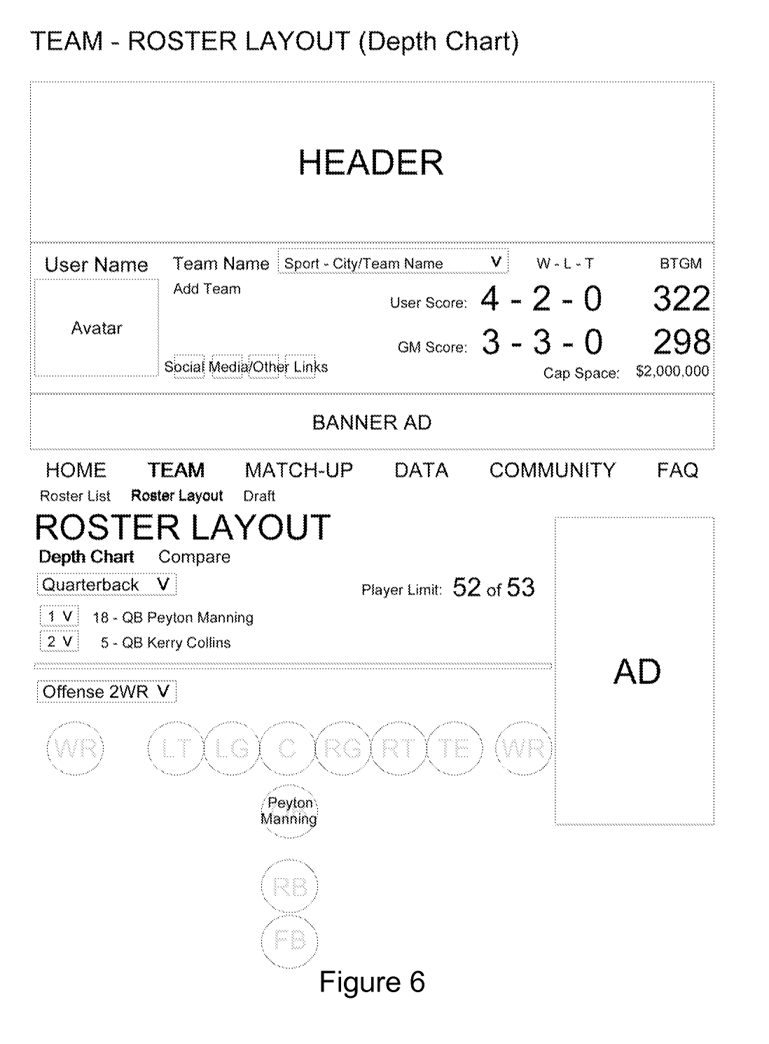

FIG. 6 illustrates a page entitled TEAM—ROSTER LAYOUT (Depth Chart) and includes:
Page Title—“Roster Layout”
Links to Subpages: Depth Chart, Compare
Positions—List of positions on team
   Drop Down list
Text—“Player limit”
Number of players on team
Number of players allowed on team
Rankings—Allows User to rank order of players, per position, on depth chart
   Drop Down list
Player Info: Number, Position, Name
Formations—Various on-field composition of players
   For football, includes: Offense 2WR, Offense 2TE, Offense 3WR, Offense 4 WR, Offense 5 WR, Defense 3-4, Defense 4-3, Special Teams, Practice Squad, and Injured Reserve
Graphic representation of selected formation
Name of top player as selected by User for each on field position

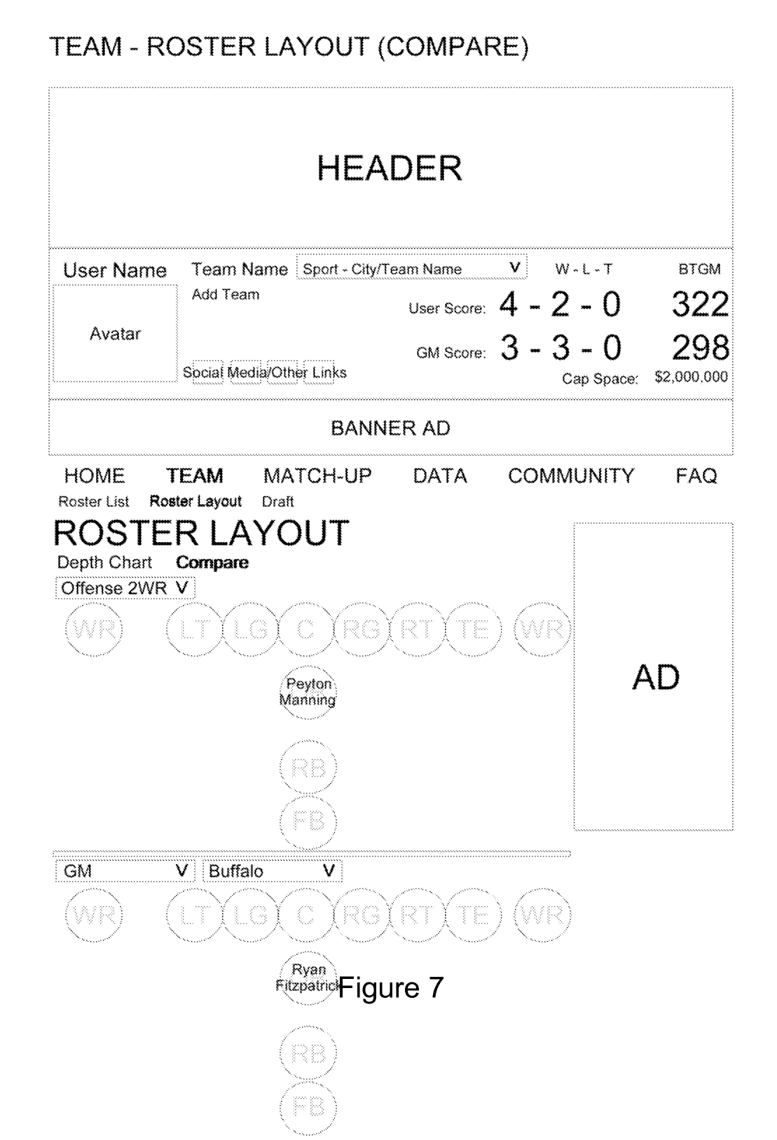

FIG. 7 illustrates a page entitled TEAM—ROSTER LAYOUT (COMPARE) and includes:
Similar to Team—Roster Layout (Depth Chart)
Bottom section of Roster Layout (Depth Chart) moves to upper area
New bottom area is similar, but displays the layout of a team as selected from two Drop Down lists:
   Category—The category of opponent
      GM (real life general managers/teams) or Friends (other Users)
   Category specifics
      If GM—list of real life teams
      If Friends—list of user names

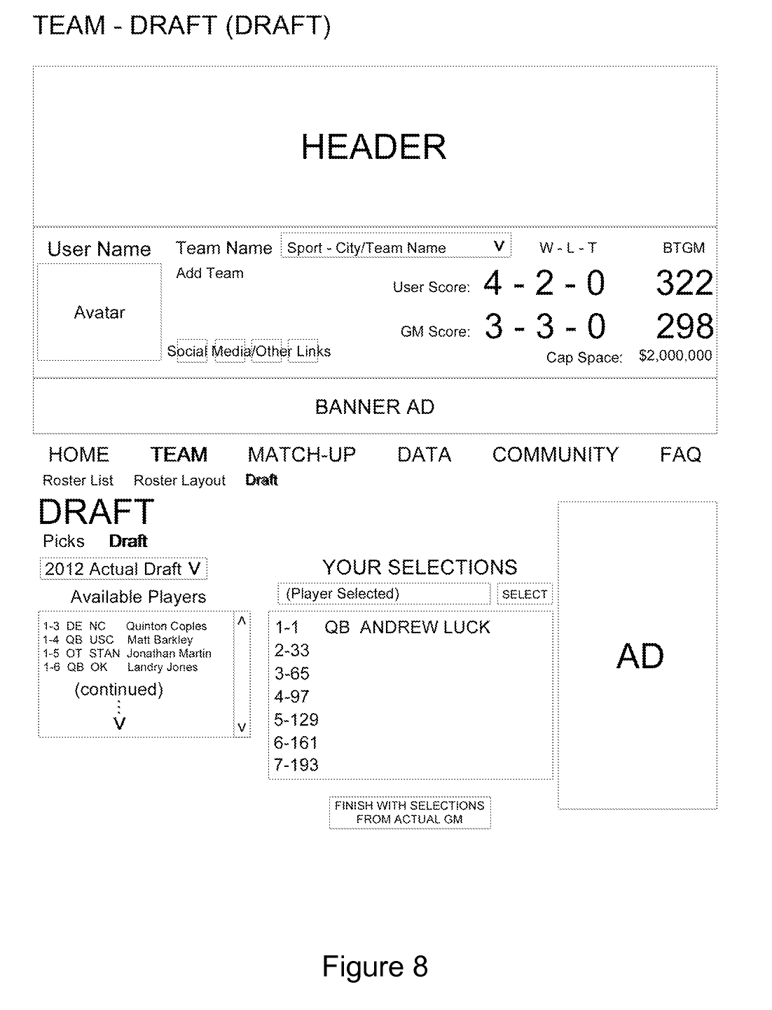

FIG. 8 illustrates a page entitled TEAM—DRAFT and includes:
Links to Pages: Roster List, Roster Layout, Draft
Page Title—“Draft”
Links to Subpages: Picks, Draft
Available draft pick listing options: Actual Draft, Name, School, Team Drafted, Position
   Drop Down list
Heading “Available Players”
Heading “Your Selection”
List of all available players for draft
   Display: Draft Position, Position, School, Name
   Scrollable/Expandable Window
Box highlights Player Selected
Button “Select” allows User to add the player in the adjacent box to his team
Display of selections
   Lists Round, Pick Number, Position, and Name
Button “Finish With Selections From Actual GM”—Allows Users to automatically fill in their remaining picks with the players from the actual draft that were taken with the corresponding pick

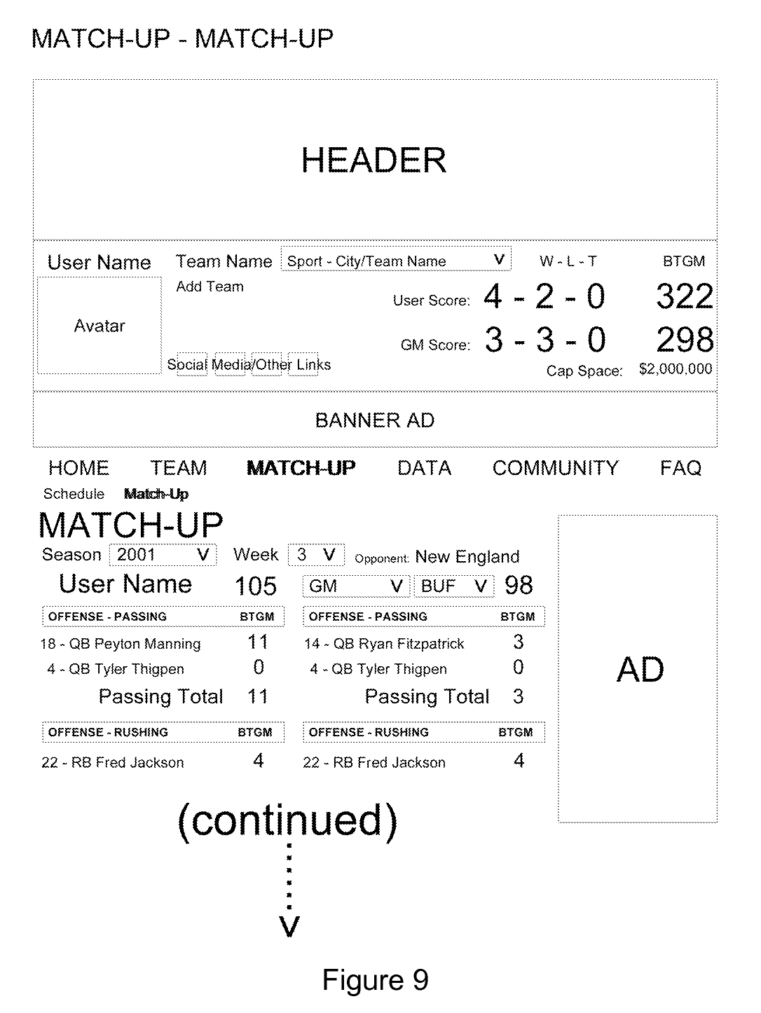

FIG. 9 illustrates a page entitled MATCH-UP and includes:
Links to Pages: Schedule, Match-Up
Page Title—“Match-UP”
Category Title—“Season”
Season Years—Lists various years to choose from
   Drop Down list
Category Title—“Week”
Week Numbers—Lists weeks 1-16 to pair with the season selected
   Drop Down list
Category Title—“Opponent”
User Team's real life opponent displayed for the Season and Week selected
User Name
User BTGM Score for that week
Opponent selection options
   Category—The category of opponent
      GM (real life general managers/teams) or Friends (other Users)
   Category specifics
      If GM—list of real life teams
      If Friends—list of user name
Selected opponent's BTGM Score for same week
Two similar columns—one for displaying User Team info, one for displaying Selected Opponent team info
Category Bar—In this example “Offense—Passing” and “Offense—Rushing”
   Each bar will have differing titles
   Each bar will have a BTGM score for each player
   Player Info: Number, Position, and Name
   BTGM Score—Appears in BTGM column in Category Bar for each respective player
   Subsection Subtotal of BTGM Total—In this example “Passing Total”

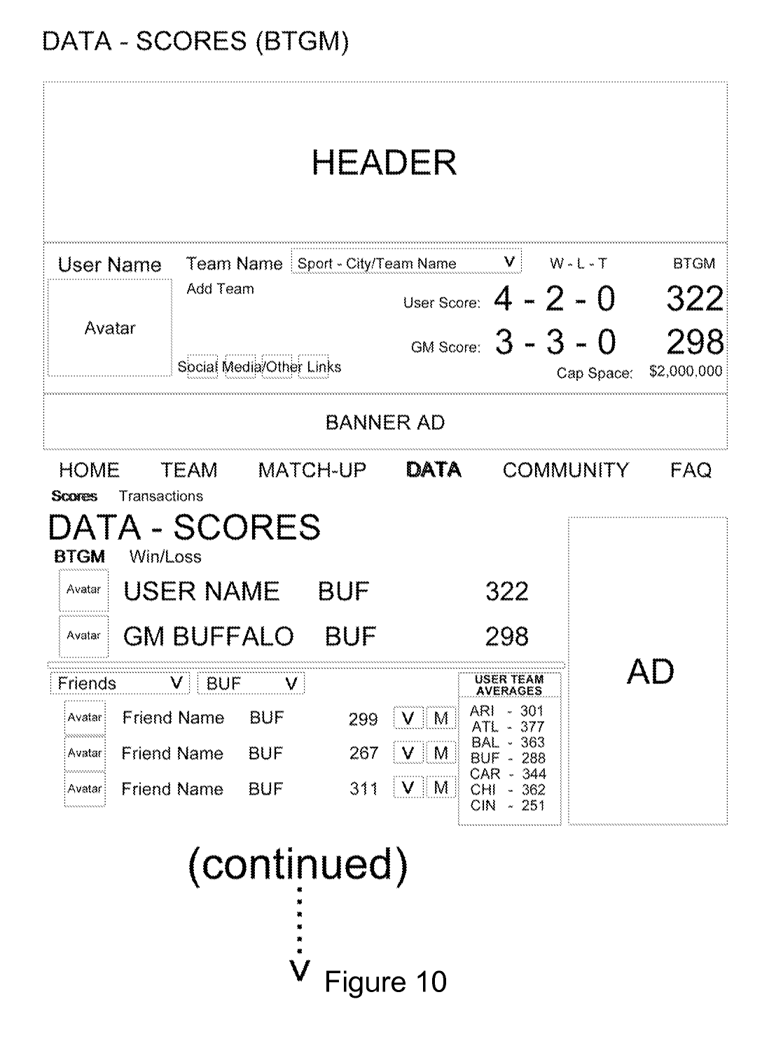

FIG. 10 illustrates a page entitled DATA and includes:
Links to Pages: Scores, Transactions
Page Title—“Data—Scores”
Links to Subpages: BTGM, Win/Loss
   These subpages would be the location of any future scoring methods
User Avatar, User Name, User Team
User BTGM Score
GM Avatar, GM Team Name, GM Team
GM BTGM Score
Data Selection Options
   Category—The category of opponent
      GM (real life general managers/teams) or Friends (other Users)
   Category specifics
      List of individual teams or “All”
List based on the chosen Data Selection Options
   Avatar, GM/Friend Name, Team
   BTGM Score of person listed
Button “V”—Stands for View
   Allows User to View Team of other GM or Friend
Button “M”—Stands for Message
   Allows User to send a message—for Friend only
Averages box—Displays data of the averages of all the BTGM Users broken down by team
   Title—“User Team Averages”
   List team with corresponding average BTGM Score

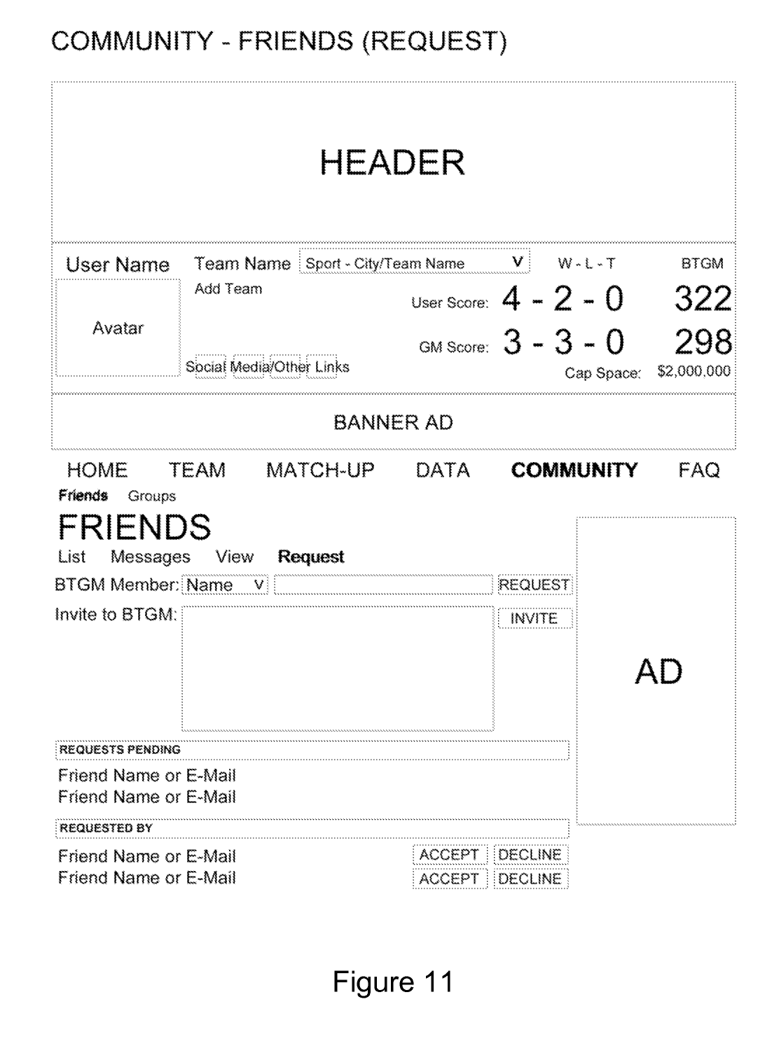

FIG. 11 illustrates a page entitled COMMUNITY—FRIENDS and includes:
Links to Pages: Friends, Groups
Page Title—“Friends”
Links to Subpages: List, Messages, View Request
Member Search Title—“BTGM Member”
BTGM Member Search options: Name, User Name, E-Mail Address
   Drop Down list
BTGM Member Name—Box to input User info
   Auto Finn from site database of Users
Button “Request”—Sends request to become a Friend to inputted User
Non-Member Search Title—“BIGM Member”
Box to input e-mail address
Button “Invite”—Sends request to become a member of BTGM and Friend to inputted addressee
Section Heading—“Requests Pending”
   Lists all the people a User has sent a Friend Request or Invite
Section Heading—“Requested By”
   Lists all the fellow Users who have Requested the User as a Friend
   Box “Accept”—Adds the Requester as a Friend
   Box “Decline”—Declines the Requester as a Friend

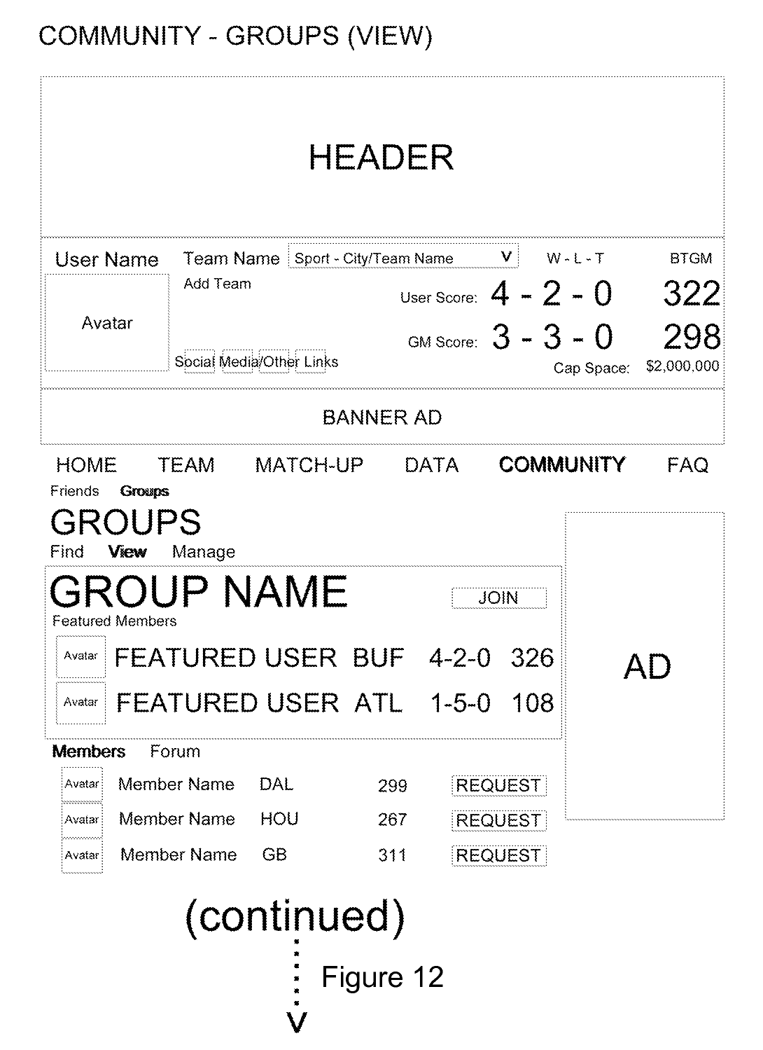

FIG. 12 illustrates a page entitled GROUPS and includes:
Links to Pages: Friends, Groups
Page Title—“Groups”
Links to Subpages: Find, View, Manage
Feature Area—Spotlights the Group and Feature Users as assigned by Group Administrators
   Title—Group Name
   Title “Featured Members”
   Button “Join”—Allows User to join Group
   Featured User(s) Avatar, Featured User(s) Name, Featured User(s) Team
   Featured User(s) Win/Loss Record
   Featured User(s) BTGM Score
Links to Secondary Subpages: Members, Forum
List Members who have joined Group
   Avatar, GM/Member Name, Team
   BTGM Score of person listed
Button “Request”—Allows User to Request the particular Member as a Friend

1. A method of conducting a fantasy sports game based in reality, comprising:
storing, in a computer memory, at least one participant in the game;
storing, in the computer memory, in association with the participant, a roster of players corresponding substantially with players on a real-life roster of a real-life sports team in a real-life league;
generating and transmitting to the participant a transaction opportunity corresponding to a player transaction in the real-life league;
receiving, via a user interface, an acceptance of the transaction opportunity; and
updating the participant's roster of players based on the participant's acceptance of the transaction opportunity.

2. The method of claim 1, further comprising compiling a composite score for the participant's roster of players based on real-life performance of each player comprising the roster of players.

3. The method of claim 2, further comprising evaluating the composite score against a composite score of an opponent roster.

4. The method of claim 3, wherein the opponent roster is one of a fantasy roster and a roster of the real life sports team.

5. The method of claim 1, wherein the transaction opportunity is offered to every participant in the game.

6. The method of claim 1, wherein the transaction opportunity is offered only to the participant having a real-life player involved in the corresponding player transaction in the real-life league.

7. The method of claim 1, further comprising imparting roster restrictions on the participant's roster of players.

8. The method of claim 7, wherein the roster restrictions include at least one of a minimum number of players, a maximum number of players, a minimum number of players per position, a maximum number of players per position, a salary cap, and a salary floor.

9. The method of claim 7, further comprising comparing an impact of acceptance of the transaction opportunity on the participant's roster to the roster restrictions.

10. The method of claim 9, further comprising predicating the accepting step on favorable impact of acceptance of the transaction opportunity.
